(19) United States
(12) Patent Application Publication
(10) Pub. No.: US 2025/0139506 A1
(43) Pub. Date: May 1, 2025

(54) TRAINING SYSTEM AND TRAINING METHOD FOR DOMAIN-SPECIFIC DATA MODEL

(71) Applicant: INSTITUTE FOR INFORMATION INDUSTRY, TAIPEI CITY (TW)

(72) Inventors: Yu-Chuan YANG, Taipei (TW); Tai-Ta Kuo, Taoyuan City (TW); Ping-I Chen, Taipei City (TW)

(21) Appl. No.: 18/515,660

(22) Filed: Nov. 21, 2023

(30) Foreign Application Priority Data
Oct. 27, 2023 (TW) 112141176

(51) Int. Cl. G06N 20/00

(52) U.S. Cl. CPC G06N 20/00

(57) ABSTRACT

A training system and a training method for a domain-specific data model are provided. The training method includes configuring a computing device to perform the following processes: generating, by a training set generation module, a training data set based on a domain knowledge graph; updating the data model based on the training data set; generating, by the training set generation module, training input text corresponding to the domain knowledge graph; inputting the training input text into the data model to obtain training output text; evaluating and generating a score by an evaluation module based on a correlation between the training output text and the domain knowledge graph; and adjusting, by a reinforcement learning module, parameters of the data model according to the score and an optimization goal of the reward model until the score meets a training completion condition, taking the data model as the domain-specific data model.

### CROSS-REFERENCE TO RELATED PATENT APPLICATION

This application claims the benefit of priority to Taiwan Patent Application No. 112141176, filed on Oct. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a system and a method, and more particularly to a training system and a training method for a domain-specific data model.

### BACKGROUND OF THE DISCLOSURE

Data models with broad response capabilities necessitate a substantial volume of textual content for learning during their training phase. The textual content typically requires manual annotation to ensure the precision of the model's responses. The training procedure is labor-intensive and time-consuming. Moreover, regular updates to the data models are essential to ensure that they can effectively respond to incoming text inputs.

Given that the aforementioned data models typically generate responses based on probability, the accuracy of the responses is often insufficient. For responses that require specific professional knowledge, data models with broad response capabilities cannot guarantee whether or not the generated response text is correct or appropriate, thus failing to meet user needs. In order to address the above issues, it is crucial that a novel training mechanism be developed, which should not only diminish the amount of manpower and time invested in training data models, but also expedite the increase in accuracy of a model's response within a specific domain.

### SUMMARY OF THE DISCLOSURE

In response to the above-referenced technical inadequacies, the present disclosure provides a training system and training method for a domain-specific data model.

In order to solve the above-mentioned problems, one of the technical aspects adopted by the present disclosure is to provide a training system for a domain-specific data model, and the training system includes a computing device. The computing device includes at least one processor and a storage unit. The storage unit stores a data model, a domain knowledge graph, a training set generation module, a reinforcement learning module based on a reward model, and an evaluation module. The computing device is configured to perform the following steps: generating, by the training set generation module, a training data set based on the domain knowledge graph, in which the training data set includes at least one record of input text and corresponding output text that correspond to the domain knowledge graph; updating the data model based on the training data set; generating, by the training set generation module, training input text corresponding to the domain knowledge graph; inputting the training input text into the data model to obtain training output text; evaluating and generating a score by the evaluation module based on a correlation between the training output text and the domain knowledge graph; and adjusting, by the reinforcement learning module, parameters of the data model according to the score and an optimization goal of the reward model until the score meets a training completion condition, and then taking the data model as the domain-specific data model.

In order to solve the above-mentioned problems, another one of the technical aspects adopted by the present disclosure is to provide a training method for a domain-specific data model, and the training method includes: configuring a computing device including at least one processor and a storage unit to perform: generating, by a training set generation module, a training data set based on a domain knowledge graph, in which the training data set includes at least one record of input text and corresponding output text that correspond to the domain knowledge graph; updating the data model based on the training data set; generating, by the training set generation module, training input text corresponding to the domain knowledge graph; inputting the training input text into the data model to obtain training output text; evaluating and generating a score by an evaluation module based on a correlation between the training output text and the domain knowledge graph; and adjusting, by a reinforcement learning module, parameters of the data model according to the score and an optimization goal of the reward model until the score meets a training completion condition, and then taking the data model as the domain-specific data model.

Therefore, in the training system and training method for the domain-specific data models provided by the present disclosure, precise knowledge of specific domains can be accurately integrated into the data model by utilizing a domain knowledge graph to increase the accuracy of the model's responses rapidly.

Moreover, throughout the training phase of the data model, the triple structure of the knowledge graph can be leveraged to devise an automated evaluating system. This innovation eliminates the necessity for human intervention in the data model's retraining cycle, leading to a substantial decrease in manual tasks, and also empowers the data model to supplement domain-specific knowledge data as required, thereby catering to user needs for knowledge pertaining to a particular domain. This advancement has the potential to expedite the growth of application services that employ generative artificial intelligence.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a training system for a domain-specific data model according to one embodiment of the present disclosure;

FIG. 2 is a flowchart of a training method for a domain-specific data model according to one embodiment of the present disclosure;

FIG. 3 is a schematic diagram of multiple triples associated with an important node according to one embodiment of the present disclosure;

FIG. 4 is a detailed flowchart of step S14;

FIG. 5 is a schematic diagram of a training output text triple structure according to one embodiment of the present disclosure;

FIG. 6 is a schematic diagram of a vector space of a domain knowledge graph according to one embodiment of the present disclosure; and

FIGS. 7 and 8 are respectively a first schematic diagram and a second schematic diagram showing an average distance of each node of training output text in the vector space of the domain knowledge graph according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

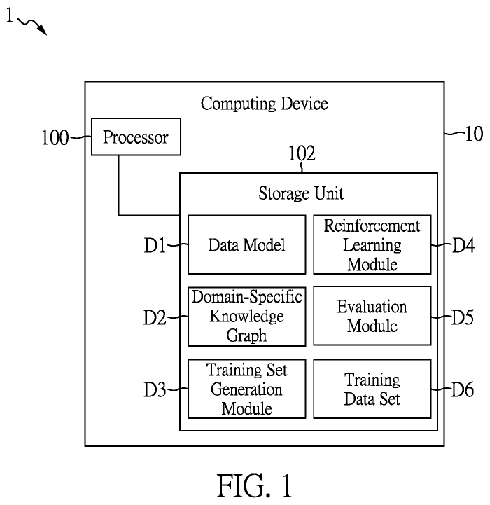

FIG. 1 is a block diagram of a training system for a domain-specific data model according to one embodiment of the present disclosure. Referring to FIG. 1, one embodiment of the present disclosure provides a training system 1 for a domain-specific data model, which includes a computing device 10. The computing device 10 includes at least one processor 100 and a storage unit 102.

In the embodiments of the present disclosure, the computing device 10 refers to various data processing devices that have specific functions and are implemented by hardware or a combination of hardware and software. These devices process and analyze information and/or generate corresponding control information through one or more processors 100. Examples of such devices include electronic controllers, servers, cloud platforms, virtual machines, desktop computers, laptops, tablets, or smartphones. The computing device 10 can include a corresponding data receiving or transmitting circuit to receive or transmit required data.

The storage unit 102 can be, for example, a non-volatile storage device such as a read-only memory (ROM), a programmable read-only memory (PROM), a cache memory, a non-volatile random-access memory (VRAM), a hard disk, an optical disk, or a magnetic tape. The storage unit 102 can be used to store necessary data, such as a data model D1, a domain knowledge graph D2, a training set generation module D3, a reinforcement learning module D4 based on a reward model, and an evaluation module D5. The processor 100 can be configured to execute a plurality of computer-readable instructions to implement processes and functions mentioned below of the data model D1, the training set generation module D3, the reinforcement learning module D4, and the evaluation module D5.

In a broad sense, the data model D1 in the present disclosure refers to a text generation model that can receive user input text and generate output text. The input text can be a single word, or two or more words that form a phrase or a sentence, such as a question or a statement. The output text can also be a single word, or two or more words that form a phrase or a sentence, such as an answer, a question sentence (for example, when further clarification or narrowing of scope is needed), or an explanatory statement. More specifically, the term “text” mentioned hereinafter is used to refer to one or more words. In general, the data model D1 can be generated through the following stages:

First stage: a large amount of corpus is input to train a model with text continuation capabilities by using machine learning methods, so as to establish an initial data model that can be used to obtain corresponding output text after inputting text, and multiple different records of output text may be obtained each time the same text is input.

Second stage: the initial data model is utilized, in which several records of output text generated by the initial data model are sorted by humans, and a reward model is then trained based on sorted results.

Third stage: the initial data model is trained again. After inputting the input text, output text is obtained. Human feedback is further on the output text and the reward model, the parameters of the initial data model are adjusted using a reinforcement learning mechanism. After continuous training, the data model D1 is generated.

Update stage of the data model D1: The updated information needs to be input into the data model D1, and then the second and third stages are repeated to train the reinforcement learning model and use human feedback and the reinforcement learning module to retrain the data model D1.

Regardless of the need for a large amount of human intervention in the multiple stages mentioned above, the trained data model D1, which can automatically generate output text, is quite insufficient in its accuracy when replying to specific domains and professional content. Therefore, the data model D1 cannot meet users' needs in specific knowledge domains.

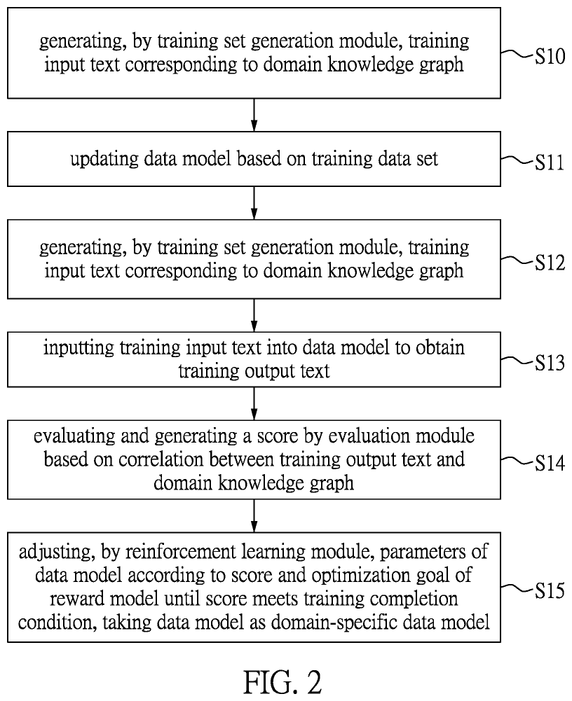

Reference is made to FIG. 2, which is a flowchart of a training method for a domain-specific data model according to one embodiment of the present disclosure. In response to the above-referenced technical inadequacies, the present disclosure provides a training method for the domain-specific data model, the training method is suitable for the training system 1 mentioned above and includes configuring the computing device 10 to perform the following steps:

Step S10: generating, by the training set generation module, training input text corresponding to the domain knowledge graph.

Knowledge graph is a structured semantic knowledge base. The generally used representation is a triplet of “entity-relationship-entity”, which is used to store interrelations among multiple entities. There are many knowledge graphs built for specific domains available on the market. These knowledge graphs serve as repositories, storing a vast array of entities and their interconnections pertinent to specific domains. When integrated with methodologies such as machine learning and deep learning, these knowledge graphs prove instrumental in processing input text characterized by intricate associations and semantic ambiguity. Over recent years, their application has become increasingly prevalent across various sectors, including but not limited to finance, healthcare, and intelligent manufacturing.

In some embodiments, tools such as a knowledge graph construction system can also be utilized to convert knowledge data or files in a specific domain into the domain knowledge graph D2. In the knowledge graph construction system, structured and semi-structured data can undergo simple preprocessing and mapping to identify nodes (i.e., entities) and relationships of triples, thereby constructing the domain knowledge graph D2. For unstructured data, technologies such as natural language processing, information extraction, and deep learning can be used to extract valid information as the nodes and the relationships of the triples. In some embodiments, a pre-built domain knowledge graph D2 can also be obtained. Since construction and acquisition methods of the domain knowledge graph D2 are known to those skilled in the art, details thereof will not be further elaborated hereinafter.

In step S10, the training data set D6 can be stored in the storage unit 102, which includes at least one record of input text and its corresponding output text that correspond to the domain knowledge graph D2, and the at least one record of input text and the corresponding output text can be generated according to one or more triples in the domain knowledge graph D2. To better mimic the way humans converse in generating the input text and its corresponding output text, multiple triples associated with a node can be extracted based on an input text template, so as to generate a series of consecutive records of input text and their corresponding output text.

The input text template can be pre-set sentences, where nouns in the sentences are replaced with blanks, and node categories needed for the blanks are set. Then, from all the nodes in the domain knowledge graph D2, one node that fits the node category is selected as a first node, and multiple other nodes with higher association with the selected first node in the domain knowledge graph D2 are calculated and selected. These selected nodes can serve as a sub-graph containing multiple triples, which can be used to generate a combination of a series of input text and corresponding output text.

In detail, distances between the multiple other nodes in the domain knowledge graph D2 and the selected first node can be analyzed first to serve as relationships of these other nodes with the first node, and the obtained relationships are then sorted. Afterward, several nodes with high association with the first node are extracted from the domain knowledge graph D2 as the multiple triples (i.e., the subgraph in the domain knowledge graph D2), so as to mimic the way humans converse to generate the input text and its corresponding output text.

In an effort to more effectively emulate human conversation when generating the input text and its corresponding output text, the multiple triples, which are associated with the key node extracted based on the input text template, can be employed to facilitate the generation of the plurality of consecutive records of input text along with their respective output text.

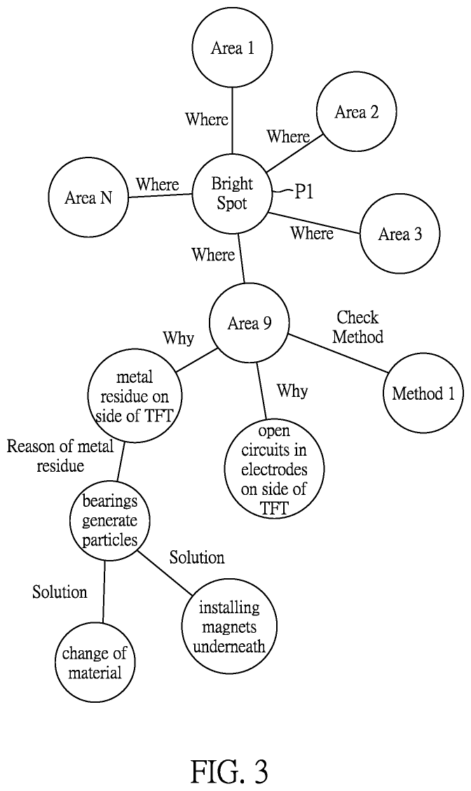

Reference is made to FIG. 3, which is a schematic diagram of multiple triples associated with an important node according to one embodiment of the present disclosure.

Taking FIG. 3 as an example, a node P1 referred to as a “bright spot” in the domain knowledge graph D2 is taken as an important node for extraction, and triples associated with the node P1 is extracted.

Then, starting from node P1, the “bright spot” can be substituted into a default input text template, and the following series of conversations between a user and a conversation robot can be generated based on the triples taken out from FIG. 3. The input text template can be, for example: Why does “A” appear? Where A is a description of a node.

User: Why does a bright spot appear?

Conversation robot: Where is the bright spot?

Conversation robot (simulating user's response): It is the bright spot of area 9 of the screen.

Conversation robot: The cause of this phenomenon could be due to metal residues on a side of the thin-film transistor causing lighting defects, or open circuits in the electrodes on the side of the thin-film transistor causing lighting defects.

Conversation robot (simulating user's question again): Please tell me the solution to the lighting defect caused by the metal residue on the side of the thin film transistor?

Conversation robot: The generation of particles from the supporting bearings used in the transmission tray may be the cause. By changing the material and installing magnets underneath, the impact of particles can be effectively suppressed.

Therefore, the plurality of consecutive records of conversations mentioned above can be used as the training data set D6 (i.e., update information) to update the data model D1.

Step S11: updating the data model based on the training data set.

This step is to input the above-mentioned input text and the output text to the data model D1 for training, thereby generating the data model D1 with domain-specific knowledge. However, the data model D1 generated after this step still needs to be further retrained through the following steps.

Step S12: generating, by the training set generation module, training input text corresponding to the domain knowledge graph.

Step S13: inputting the training input text into the data model to obtain training output text.

Step S14: evaluating and generating a score by the evaluation module based on a correlation between the training output text and the domain knowledge graph.

In steps S12 to S13, the training set generation module D3 can generate the training input text in a similar way to step S10, which can be, for example, a plurality of consecutive records of input text. The training output text includes multiple records of output text generated by the data model D1 with domain-specific knowledge and corresponding to the consecutive records of input text.

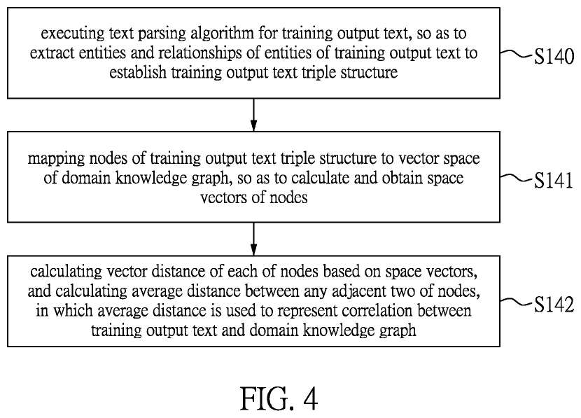

Reference is made to FIG. 4, which is a detailed flowchart of step S14. In this embodiment, the evaluation module D5 of step S14 can be used to perform the following steps:

Step S140: executing a text parsing algorithm for the training output text, so as to extract entities and relationships of the entities of the training output text to establish a training output text triple structure.

As mentioned above, by executing a text parsing algorithm on (one or more records of) the training output text, entities and associations can be extracted from the multiple records of output text corresponding to the multiple records of input text, thereby establishing the training output text triple structure. In step S140, the text parsing algorithm can include, for example, a named entity recognition (NER) algorithm and a relationship extraction algorithm.

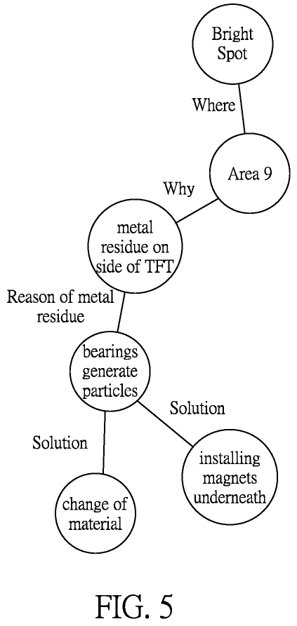

For example, reference can be made to FIG. 5, which is a schematic diagram of a training output text triple structure according to one embodiment of the present disclosure. As shown in FIG. 5, if the output text of the conversation robot in the aforementioned series of conversations is used as the training output text for extracting the entities and the relationships, the triple structure shown in FIG. 5 can be obtained.

Step S141: mapping a plurality of nodes of the training output text triple structure to a vector space of the domain knowledge graph, so as to calculate and obtain a plurality of space vectors of the plurality of nodes.

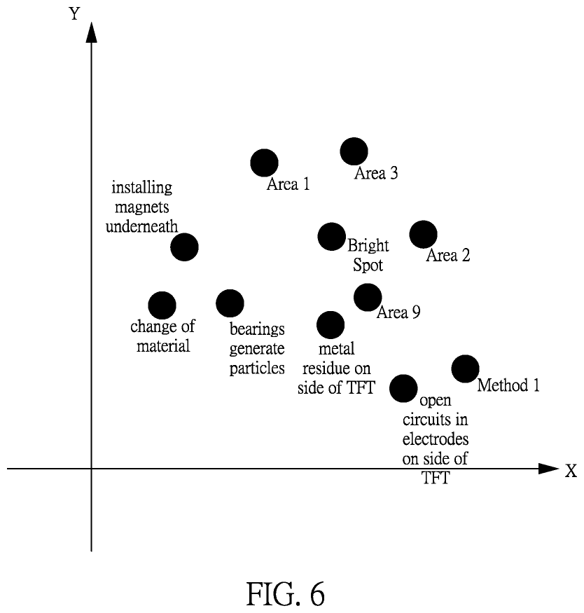

FIG. 6 is a schematic diagram of a vector space of a domain knowledge graph according to one embodiment of the present disclosure. Referring to FIG. 6, before step S141 is performed, the vector space of the domain knowledge graph D2 must be established by executing a mapping algorithm on all triples of the domain knowledge graph D2. The mapping algorithm can be, for example, a message passing algorithm or a random walk algorithm. The entities will take the associated node information into consideration through the mapping algorithm. In other words, the closer the distances among several entities in the vector space, the stronger the associations among these entities. Although FIG. 6 displays the vector space of the domain knowledge graph D2 in a two-dimensional space, it is merely illustrative. The present disclosure does not limit dimensions of the vector space of the domain knowledge graph.

Therefore, in step S141, nodes of the training output text triple structure in FIG. 5 can be mapped to the vector space of the domain knowledge graph D2 in a similar manner (i.e., the mapping algorithm mentioned above) to calculate and obtain the space vectors of the nodes in the training output text triple structure.

For example, the nodes in the training output text can be represented by X and Y coordinates (x, y) in FIG. 6. If the node of the training output text triple structure does not appear in the vector space of the domain knowledge graph D2, then the coordinates of the node will be (0,0).

Step S142: calculating a vector distance of each of the nodes based on the plurality of space vectors, and calculating an average distance between any adjacent two of the nodes, in which the average distance is used to represent a correlation between the training output text and the domain knowledge graph. In this step, the shorter the average distance, the higher the correlation between the training output text and the domain knowledge graph D2. That is to say, the shorter the average distance, the more the structure of the training output text conforms to the structure of the domain knowledge graph D2, and it is the better training output text. If the average distance is larger, it means that the structure of the training output text does not conform to the structure of the domain knowledge graph D2, and it is the less-qualified output text.

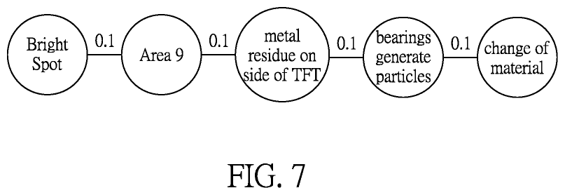

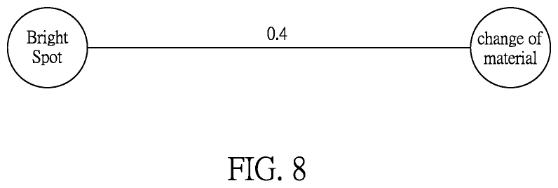

FIGS. 7 and 8 are respectively a first schematic diagram and a second schematic diagram showing an average distance of each node of training output text in the vector space of the domain knowledge graph according to one embodiment of the present disclosure. Referring to FIG. 7, if nodes in the vector space of the domain knowledge graph D2 mapped from the training output text triple structure are “bright spot”, “area 9”, “metal residues on the side of the TFT”, “bearings generate particles” and “change of material”, then the average distances among these nodes can be obtained as 0.1 units. This can be used to represent the correlation between the output text and the nodes in the domain knowledge graph in the series of conversations. The shorter the average distance, the more the nodes in the output text conform to the adjacent structure in the domain knowledge graph. As shown in FIG. 8, if the nodes are “bright spot” and “change of material” in the vector space of the domain knowledge graph D2 mapped from the training output text triple structure, then the average distance between these nodes can be obtained as 0.4 units. Compared with FIG. 7, it can be seen that in the vector space corresponding to the domain knowledge graph, the nodes in the output text of FIG. 8 are relatively non-adjacent nodes in the domain knowledge graph D2, and its correlation to the domain knowledge graph D2 is lower, which is the less-qualified output text. In this way, the evaluation module D5 can use the obtained average distance as the score of the reward model in the reinforcement learning mechanism to replace human feedback, thus reducing the required labor costs.

Step S15: adjusting, by a reinforcement learning module, parameters of the data model according to the score and an optimization goal of the reward model until the score meets a training completion condition, taking the data model as the domain-specific data model.

It should be noted that in the process of establishing the data model D1, the parameters of the data model D1 are adjusted through the reinforcement learning mechanism that includes the reward model after receiving human feedback on the output text. The reinforcement learning module D4 further uses the evaluation module D5 to continuously sample and calculate error values based on the score generated by the average distance, thereby determining how to adjust relevant parameters (i.e., a reward function, a learning rate, and the like) of the data model D1 with domain-specific knowledge. For example, the parameters of the data model D1 will be adjusted in a direction of reducing the error value. Through continuous repeated training, until the output text generated associated with the domain-specific knowledge meets the training completion condition, the training is complete. It should be emphasized that the training completion condition can be defined through the evaluation module D5. For example, for the output text generated by the data model D1, if the average distance calculated by the scoring module D5 is less than a target value, for example, less than or equal to 0.1 units, it indicates that the output text has a higher relevance to the domain knowledge graph D2, representing that the data model D1 with the domain-specific knowledge can already answer the output text with high accuracy for the domain knowledge graph D2, then the training is complete.

In conclusion, in the training system and training method for the domain-specific data models provided by the present disclosure, precise knowledge of specific domains can be accurately integrated into the data model by utilizing a domain knowledge graph to increase the accuracy of the model's responses rapidly.

Moreover, throughout the training phase, the triple structure of the knowledge graph can be leveraged to devise an automated evaluating system. This innovation eliminates the necessity for human responses in the data model's retraining cycle, leading to a substantial decrease in manual tasks, and also empowers the data model to supplement domain-specific knowledge data as required, thereby catering to user needs for knowledge pertaining to a particular domain. This advancement has the potential to expedite the growth of application services that employ generative artificial intelligence.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A training system for a domain-specific data model, the training system comprising:
a computing device including at least one processor and a storage unit, wherein the storage unit stores a data model, a domain knowledge graph, a training set generation module, a reinforcement learning module based on a reward model, and an evaluation module, and the computing device is configured to perform the following processes:
generating, by the training set generation module, a training data set based on the domain knowledge graph, wherein the training data set includes at least one record of input text and corresponding output text that correspond to the domain knowledge graph;
updating the data model based on the training data set;
generating, by the training set generation module, training input text corresponding to the domain knowledge graph;
inputting the training input text into the data model to obtain training output text;
evaluating and generating a score by the evaluation module based on a correlation between the training output text and the domain knowledge graph; and
adjusting, by the reinforcement learning module, parameters of the data model according to the score and an optimization goal of the reward model until the score meets a training completion condition, and then taking the data model as the domain-specific data model.

2. The training system according to claim 1, wherein the process of generating the training data set further includes: generating the at least one record of input text and the corresponding output text according to one or more triples in the domain knowledge graph.

3. The training system according to claim 2, wherein the step of generating the at least one record of input text and the corresponding output text according to the one or more triples in the domain knowledge graph further includes: retrieving a node from the domain knowledge graph; and generating the at least one record of input text and the corresponding output text based on an input text template and one or more triples associated with the node.

4. The training system according to claim 3, wherein the process of generating the training data set that includes the at least one record of input text and the corresponding output text further includes: generating, according to a plurality of triples associated with the retrieved node and the input text template to generate a plurality of consecutive records of input text and the corresponding output text.

5. The training system according to claim 1, wherein the step of evaluating and generating the score by the evaluation module further includes:
executing a text parsing algorithm on the training output text, so as to extract entities and relationships of the entities of the training output text to establish a training output text triple structure;
mapping a plurality of nodes of the training output text triple structure to a vector space of the domain knowledge graph, so as to calculate and obtain a plurality of space vectors of the plurality of nodes; and
calculating a vector distance of each of the nodes based on the plurality of space vectors, and calculating an average distance between any adjacent two of the nodes, wherein the average distance is used to represent a correlation between the training output text and the domain knowledge graph.

6. The training system according to claim 5, wherein the training completion condition is met in response to the average distance being less than a target value.

7. The training system according to claim 5, wherein the vector space of the domain knowledge graph is established by executing a mapping algorithm on all of the triples of the domain knowledge graph.

8. The training system according to claim 5, wherein the training input text includes a plurality of consecutive records of input text, the training output text is a plurality of records of output text that respectively correspond to the plurality of consecutive records of input text, and the step of generating the score further includes: executing the text parsing algorithm on the training output text to extract entities and relationships of the entities of the plurality of records of output text, so to establish the training output text triple structure.

9. A training method for a domain-specific data model, the training method comprising:
configuring a computing device including at least one processor and a storage unit to perform the following processes:
generating, by a training set generation module, a training data set based on a domain knowledge graph, wherein the training data set includes at least one record of input text and corresponding output text that correspond to the domain knowledge graph;
updating the data model based on the training data set;
generating, by the training set generation module, training input text corresponding to the domain knowledge graph;
inputting the training input text into the data model to obtain training output text;
evaluating and generating a score by an evaluation module based on a correlation between the training output text and the domain knowledge graph; and
adjusting, by a reinforcement learning module, parameters of the data model according to the score and an optimization goal of the reward model until the score meets a training completion condition, and then taking the data model as the domain-specific data model.

10. The training method according to claim 9, wherein the process of generating the training data set further includes: generating the at least one record of input text and the corresponding output text according to one or more triples in the domain knowledge graph.

11. The training method according to claim 9, wherein the process of generating the at least one record of input text and the corresponding output text according to the one or more triples in the domain knowledge graph further includes: retrieving a node from the domain knowledge graph; and generating the at least one record of input text and the corresponding output text based on an input text template and one or more triples associated with the node.

12. The training method according to claim 11, wherein the process of generating the training data set that includes the at least one record of input text and the corresponding output text further includes: generating, according to a plurality of triples associated with the retrieved node and the input text template to generate a plurality of consecutive records of input text and the corresponding output text.

13. The training method according to claim 9, wherein the process of evaluating and generating the score by the evaluation module further includes:
executing a text parsing algorithm on the training output text, so as to extract entities and relationships of the entities of the training output text to establish a training output text triple structure;
mapping a plurality of nodes of the training output text triple structure to a vector space of the domain knowledge graph, so as to calculate and obtain a plurality of space vectors of the plurality of nodes; and
calculating a vector distance of each of the nodes based on the plurality of space vectors, and calculating an average distance between any adjacent two of the nodes, wherein the average distance is used to represent a correlation between the training output text and the domain knowledge graph.

14. The training method according to claim 13, wherein the training input text includes a plurality of consecutive records of input text, the training output text is a plurality of records of output text that respectively correspond to the plurality of consecutive records of input text, and the process of generating the score further includes: executing the text parsing algorithm on the training output text to extract entities and relationships of the entities of the plurality of records of output text, so to establish the training output text triple structure.
